(19) United States
(12) Patent Application Publication
(10) Pub. No.: US 2007/0005791 A1
(43) Pub. Date: Jan. 4, 2007

(54) METHOD AND SYSTEM FOR CONTROLLING AND ADAPTING MEDIA STREAM

(75) Inventors: David L. Goulden, Redwood City, CA (US); Thomas Lorek, San Francisco, CA (US); Anthony Martin, Los Altos, CA (US); Matthew Shevach, San Francisco, CA (US)

Correspondence Address: CLARIA CORPORATION;c/o HAYNES BEFFEL & WOLFELD LLP, P.O. BOX 366, 751 KELLY STREET, HALF MOON BAY, CA, 94019, US

(73) Assignee: Claria Corporation, Redwood City, CA (US)

(21) Appl. No.: 11/427,243

(22) Filed: Jun. 28, 2006

Related U.S. Application Data
(60) Provisional application No. 60/694,533, filed on Jun. 28, 2005.

(51) Int. Cl. G06F 15/16

(52) U.S. Cl. 709/231

(57) ABSTRACT

A method for controlling and adapting a media stream from multiple providers to a cluster of users. The first step of the process consists of providing a media server for receiving media content from multiple sources and distributing such content to multiple media outlets, the server including a behavior monitoring module. Next occurs the step of providing a categorization source having information about media content, followed by creating one or more user profiles reflecting user preferences for media delivery. Then the system carries out monitoring user behavior regarding media consumption and interacting with the categorization source to report user behavior and receive media source categorization information. The final steps are updating user profiles to reflect observed behavior and received categorization information, and adapting media streams to particular users by suggesting or inserting content, based on an updated user profile.

### RELATED APPLICATION

This application claims the benefit of U.S. Provisional Patent Application No. 60/694,533 entitled “Publishing Behavioral Observations to Customers” filed on Jun. 28, 2005. That application is incorporated by reference for all purposes.

### BRIEF DESCRIPTION OF THE DRAWINGS

FIG. 1 illustrates an embodiment of a system for controlling and adapting a media stream from multiple sources to multiple users.

FIG. 2 illustrates and embodiment of a media server employed in the system of FIG. 1.

### SUMMARY OF THE INVENTION

An aspect of the invention is a method for controlling and adapting a media stream from multiple providers to a cluster of users. The first step of the process consists of providing a media server for receiving media content from multiple sources and distributing such content to multiple media outlets, the server including a behavior monitoring module. Next occurs the step of providing a categorization source having information about media content, followed by creating one or more user profiles reflecting user preferences for media delivery. Then the system carries out monitoring user behavior regarding media consumption and interacting with the categorization source to report user behavior and receive media source categorization information. The final steps are updating user profiles to reflect observed behavior and received categorization information, and adapting media streams to particular users by suggesting or inserting content, based on an updated user profile.

### DETAILED DESCRIPTION

The following detailed description is made with reference to the figures. Preferred embodiments are described to illustrate the present invention, not to limit its scope, which is defined by the claims. Those of ordinary skill in the art will recognize a variety of equivalent variations on the description that follows.

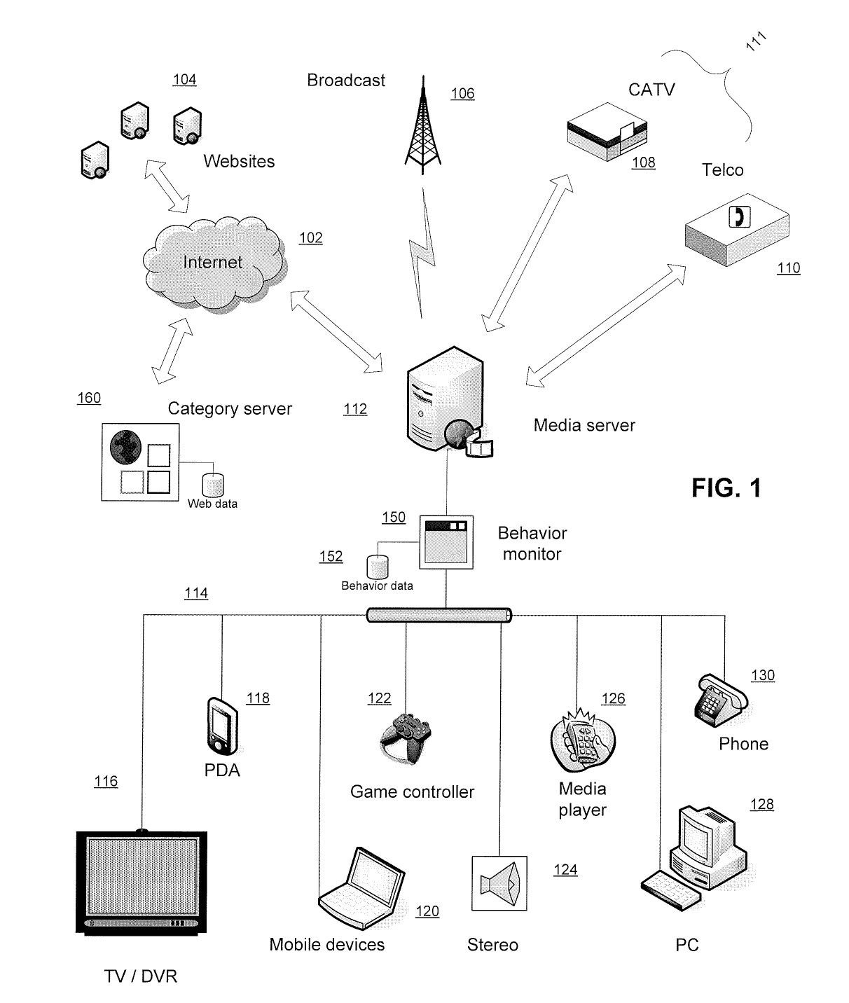

FIG. 1 depicts an interconnected system that embodies the claims appended hereto. A wide variety of elements can be incorporated into such a system, as will be clear from the description below, but the embodiment shown here illustrates the key principles set out in the claims.

In general, the system can be seen as a cluster of media sources and a cluster of media consumers, with content flowing from the former to the latter through a number of channels, all concentrated into a single stream at a distribution point. The stream is monitored, adapted and controlled at a media server, with control elements located locally and centrally. The following discussion describes each of these portions in detail.

The media sources can be visualized as all providers of media content that can be accessed by a home or business user. Clearly, that is a broad category, and the examples one can cite can only be exemplary and not exhaustive. As shown, common sources of media content can include the internet 102, which is of course more strictly speaking only a medium via which websites 104 interact with users. Broadcast media 106 provide content through a number of channels, such as direct network broadcasting or satellite broadcasting. Such devices generally require the use of a tuner or similar device to detect broadcast signals and convert them into a form that can be distributed over a local network. Tuners and the like of this form are widely known to those in the art and readily available through commercial sources. Similar to broadcast sources are cable television (CATV) sources 108. Both satellite television and CATV have expanded beyond traditional broadcast and cable channels to provide a variety of media content, including music, public affairs and other programming.

Telephone companies 110 are an emerging group of content providers, due primarily to the growing demand of mobile handset users for content beyond normal telephone connectivity, include downloadable items such as ring tones, programs and the like, as well as internet connectivity and RSS/Atom feeds of information related to news headlines, sports results, stock market prices, and weather information. In addition, the growing capabilities of user devices (computers, PDA's and the like) give them the full capability to acts as telephone receivers, eliminating the need for traditional single-function handsets.

It should be noted that an important development of recent years has been the provision of high-speed internet services by both CATV, satellite television and telephone companies. The former have primarily offered cable-modem based services and the latter DSL, but the trend toward consolidation of media providers has been remarkable.

It will be understood that development of content providers is an area that is in considerable flux, responding to technological developments and user market demands. The concepts set out in the claims below are users and beneficiaries of such developments, and thus it should be understood that terms such as “media content provider” as used herein are intended in the widest possible sense, and the scope of such claims should not be limited to the identity or technology of media providers existing when the text here is filed.

At the other end of the chain shown in FIG. 1 are the consumers of media content. The embodiment of FIG. 1 depicts a cluster of media consumers, located in relative proximity and sharing connection to media sources 111 via a network 114. Typical such scenarios include a home or small business. The network 114 can be configured either as wired, wireless or some combination there of, at the user's discretion. The claims set out below are not limited by the nature of such network, and it is specifically envisioned that network technology will improve and change over time. Such changes do not affect the concepts set out herein and claimed below.

A variety of individual media devices are connected to the network 114. The first item, TV/DVR 116 has heretofore not often been connected via comprehensive home networks, but that situation is changing rapidly. It is common for users to employ a single source for television content, for example, and to connect user devices throughout the home to that source. The ability to interconnect such devices through an Ethernet or wireless network is a step toward interconnection across media lines.

That trend is carried forward in the network of FIG. 1, which depicts a complete integration of media consuming devices on the network. In addition to television/DVR sources, the network also accommodates personal digital assistants (PDA's) 118, mobile devices such as laptop computers 120, game controllers 122, stereo systems 124, media players 126, desktop PC's 128, and telephones 130.

The interconnection point between the network and the media sources is a media server 112. As shown in the embodiment of FIG. 1, this device is in one embodiment a personal computer, equipped with appropriate interface devices to make connections with the media sources listed above, as well as local network interfaces (via a network interface card configured for an Ethernet or other wired network, or for a wireless network). A separate computer could be devoted to performing this function in other embodiments, or (more probably), a portion of the computing resources of a general purpose computer at the location will be devoted to performing the media server functions. It is anticipated that over time the power of computing devices will most likely increase to the point that ever smaller devices are able to fulfill the functions set out here. The key point will be the performance of these functions, rather than the specific hardware involved. The power of desktop computers has grown to the point at which such a computer can be devoted to performing the media server function with no loss of capability for tasks such as home record-keeping or word processing. Those of skill in the art are capable of identifying requirements at the time of installation and of selecting and installing appropriate equipment.

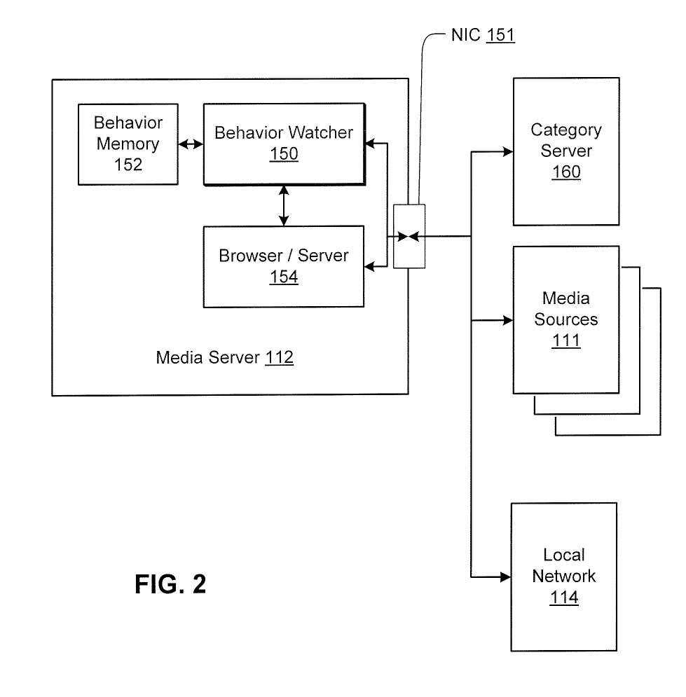

FIG. 2 depicts a functional diagram of media server 112. As noted above, this component can be a standalone computing device, or the functional blocks shown in FIG. 2 can reside in a multi-use device. As also discussed above, the media server communicates with local network 114 and various media sources via a network, ported through a conventional NIC 151.

The basic server functions are performed by browser/server software module 154. This software can be any of the software readily available from suppliers such as Microsoft, Red Hat, or the like, capable of providing the functionality both of an internet browser (such as Microsoft INTERNET EXPLORER, or alternatives such as OPERA or FIREFOX) and a server, such as Microsoft NT or the open source APACHE server.

The media stream that transits the server is monitored by behavior watching software 150. The application of such software to internet usage has been disclosed in a number of U.S. patent applications commonly owned by the assignee hereof, principally U.S. patent application Ser. No. 11/226,066, entitled “Method and Device for Publishing Cross-Network User Behavioral Data” filed on 14 Sep. 2005, hereby incorporated by reference for all purposes. As suggested there, a behavior-watching module monitors the content being transmitted by media sources, as well as any navigation information generated by a local network device (such as search request, advertising click-through, or the like). Such information is stored locally in behavior memory 152, and it is periodically forwarded to a centralized processing facility, as discussed below. Such transmissions can take the form of standardized cookies, specialized cookies, or specialized messages. The internet provides a fast and efficient method of communication, whether by cookies or standard messages.

This centralized facility is the category server 160, shown in both FIG. 1 and FIG. 2. The process of website categorization is discussed in commonly-owned applications, including U.S. patent application Ser No. 11/377,932, entitled “Method for Providing Content to an Internet User Based on the user's Demonstrated Content Preferences,” filed Mar. 16, 2006. That application, hereby incorporated by reference for all purposes, sets forth a general method for organizing a hierarchical category system for websites, which provides a system of several thousand commercially-significant categories, with which individual websites are associated.

Here, the same methodology is employed, extending the same categorization scheme to all media content, rather than only websites. The wide variety of metadata that accompanies or is available concerning content such as motion pictures or television will allow the system to categorize such content readily.

Having categorization information and user behavior information, the categorization server can proceed to construct user profiles, as disclosed in the cited applications. Moreover, the combination of categorization and profile information can be used to provide a number of services to users on the local network. First, users can be alerted to content that matches their demonstrated profiles. It is a commonplace that the advent of television offerings numbering in the hundreds of channels has left viewers largely in the dark about the programming actually on offer. Many of the current subscriber services allow users to look for particular movie stars, for example, but none can analyze past user behavior to predict that the user will most likely be interested in a new show, for example. In that way, users can gain access to content that is available but not readily accessible to the ordinary viewer.

Second, the user receives recommendations based on real-life actions, taken over time, rather than a few vague preferences expressed during set-up. Consumer preferences change over time, and most people rarely return to configuration screens to update such preferences. The present system, however, tracks current actions to draw conclusions about existing preferences. The vastly improved quality and quantity of input allows for similarly improved output.

Finally, the user can receive timely and accurate commercial information, precisely tied to actions. The present system can integrate user actions on the internet and television, for example, to determine that a new motion picture is likely of interest, and that information can be communicated in a clear and timely manner.

While the present invention is disclosed by reference to the preferred embodiments and examples detailed above, it is understood that these examples are intended in an illustrative rather than in a limiting sense. Computer-assisted processing is implicated in the described embodiments. It is contemplated that modifications and combinations will readily occur to those skilled in the art, which modifications and combinations will be within the spirit of the invention and the scope of the following claims.

We claim as follows:

1. A method for controlling and adapting a media stream from multiple providers to a cluster of users, comprising the steps of:
providing a media server for receiving media content from multiple sources and distributing such content to multiple media outlets, the server including a behavior monitoring module;
providing a categorization source having information about media content;
creating one or more user profiles reflecting user preferences for media delivery;
monitoring user behavior regarding media consumption;
interacting with the categorization source to report user behavior and receive media source categorization information;
updating user profiles to reflect observed behavior and received categorization information; and
adapting media streams to particular users by suggesting or inserting content, based on an updated user profile.
